(19) United States
(12) Patent Application Publication
(10) Pub. No.: US 2018/0164897 A1
(43) Pub. Date: Jun. 14, 2018

(54) Handheld split keyboard

(71) Applicant: Geartonomy, Inc., Freemont, CA (US)

(72) Inventor: Richard Yao Tien Huang, Fremont, CA (US)

(21) Appl. No.: 15/374,915

(22) Filed: Dec. 9, 2016

(51) Int. Cl. G06F 3/02; G06F 1/16; G06F 3/023

(52) U.S. Cl. CPC G06F 3/0202; G06F 2203/0384; G06F 3/0231; G06F 1/1669

(57) ABSTRACT

A handheld split keyboard system includes first and second keyboard sections, each including a body and a plurality of front mounted keys; such that the keyboard sections are configured to be held in first and second hands of a user who types with first and second thumbs. Additionally, the keyboard sections can include rear mounted keys for typing with index and middle fingers. The keyboard sections can be removably attachable to a tablet or laptop computer, and they can be joinable to each other. Also disclosed is a method for using a handheld keyboard system, including holding first and second keyboard sections, and typing on the keyboard sections to transmit keystroke information to a computer device.

### CROSS-REFERENCE TO RELATED APPLICATIONS

N/A.

### FIELD OF THE INVENTION

The present invention relates generally to the field of keyboards for computer devices, and more particularly to methods and systems for handheld split keyboards, which optionally are attachable to a tablet computer.

### BACKGROUND OF THE INVENTION

Split keyboards that are either permanently attached or are designed to attach to sides of a computer device, are well-known and for some users offer ergonomic advantages over conventional keyboards.

However, such keyboards are limited in the applications and do not offer users optimal freedom to use each hand independently for typing.

As such, considering the foregoing, it may be appreciated that there continues to be a need for novel and improved devices and methods for split keyboards.

### SUMMARY OF THE INVENTION

The foregoing needs are met, to a great extent, by the present invention, wherein in aspects of this invention, enhancements are provided to the existing model of split keyboards.

In an aspect, a handheld split keyboard system includes:
a) a first keyboard section, including:
   a first body;
   a first plurality of front keys, which are mounted on a front side of the first body; and
b) a second keyboard section, comprising:
   a second body;
   a second plurality of front keys, which are mounted on a front side of the second body;
wherein the first and second keyboard sections are configured for handheld use, such that the first and second keyboard sections are configured to be held by respectively a first hand and a second hand of a user;
wherein the first and second keyboard sections are configured to communicate keystroke information to a computer device via a wireless connection.

In a related aspect, the first and second keyboard sections can be configured for typing with a first thumb and a second thumb of the user

In another related aspect, the handheld split keyboard system can further include:
a) at least one first rear key that is mounted on a rear side of the first body; and
b) at least one second rear key that is mounted on a rear side of the second body.

In yet another related aspect, the right and left keyboard sections can be removably attachable to sides of a tablet computer.

In another related aspect, the first and second keyboard sections can be removably attachable to each other.

In an aspect, a method for using a handheld keyboard system, includes:
a) a user holding a first keyboard section with a first hand;
b) the user holding a second keyboard section with a second hand;
c) the user typing on a computer device by:
   depressing first keys on the first keyboard section, such that first keystroke information is transmitted from the first keyboard section to the computer device; and
   depressing second keys on the second keyboard section, such that second keystroke information is transmitted from the second keyboard section to the computer device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a handheld split keyboard system, according to an embodiment of the invention.

FIG. 2 is a perspective view illustrating a handheld keyboard section, according to an embodiment of the invention.

FIG. 3A is a perspective view illustrating a split keyboard system mounted on a tablet, according to an embodiment of the invention.

FIG. 3B is a top view illustrating a split keyboard system, according to an embodiment of the invention.

FIG. 4A is a front view illustrating a split keyboard system, according to an embodiment of the invention.

FIG. 4B is a front view illustrating a split keyboard system, which has been connected to form one piece, according to an embodiment of the invention.

FIG. 4C is a side view illustrating facing sides of the split keyboard system, according to an embodiment of the invention.

FIG. 5 is a front view illustrating a split keyboard system, according to an embodiment of the invention.

FIG. 6 is a rear perspective view illustrating a top part of a handheld keyboard device, according to an embodiment of the invention.

FIG. 7A is a schematic diagram illustrating a handheld keyboard system connected to a computer device, according to an embodiment of the invention.

FIG. 7B is a schematic diagram illustrating a handheld keyboard system connected to a computer device, according to an embodiment of the invention.

FIG. 8 is a schematic diagram illustrating a handheld keyboard section, according to an embodiment of the invention.

FIG. 9 is a flowchart illustrating steps that may be followed, in accordance with one embodiment of a method or process of using a handheld keyboard system.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

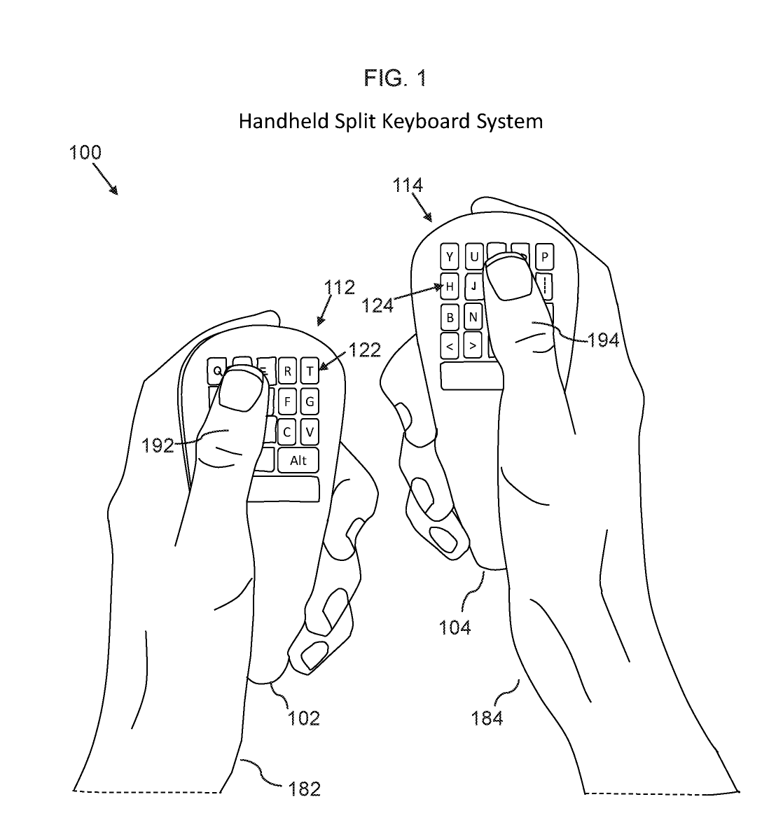

In the following, we describe the structure of an embodiment of a handheld split keyboard system 100 with reference to FIG. 1, in such manner that like reference numerals refer to like components throughout; a convention that we shall employ for the remainder of this specification.

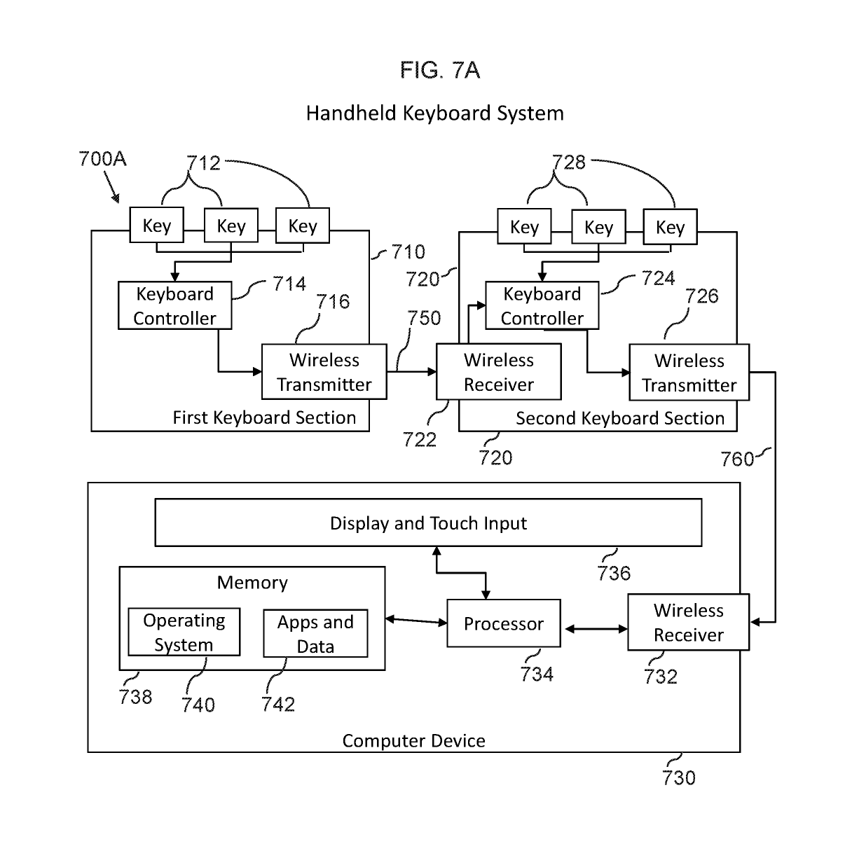

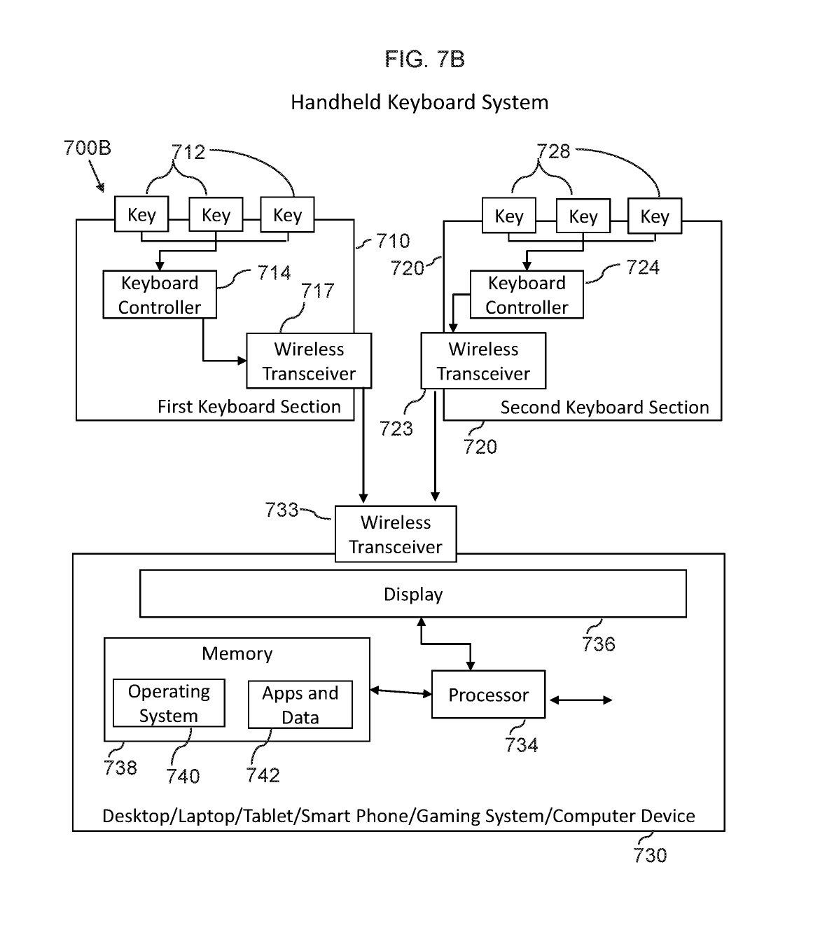

In an embodiment a handheld split keyboard system 100 can include:
a) a first keyboard section 112, which can also be referred to as a left keyboard section 112, including:
   i. a first keyboard body 102;
   ii. a first plurality of keys 122, which are mounted on a front side of the first keyboard body 102; and
b) a second keyboard section 114, which can also be referred to as a right keyboard section 114, including:
   i. a second keyboard body 104;
   ii. a second plurality of keys 124, which are mounted on a front side of the second keyboard body 114;
wherein the first and second keyboard sections are configured for handheld use, in order to be held by respectively a first hand 182 and a second hand 184 of a user;
wherein the first and second keyboard sections 112 114 are configured to communicate keystroke information to a computer device 730 via a wireless connection, as shown in FIGS. 7A and 7B, which for example can be a computer tablet, a laptop, a desktop computer, a smart phone, a gaming system/console, a smart tv, a tv set-top box/unit, or some other computer device.

In a related embodiment, the first and second keyboard sections 112 114 can be configured for typing with respectively a first thumb 192 and a second thumb 194 depressing keys of respectively the first and second plurality of keys 122 124.

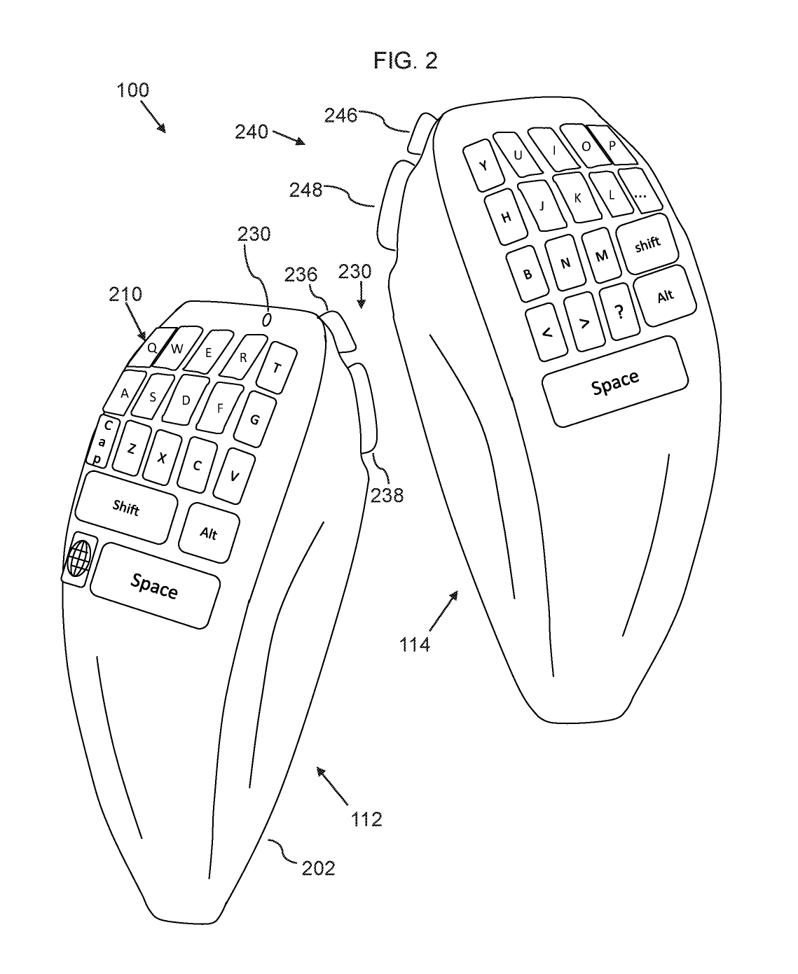

In another related embodiment, as shown in FIG. 2, the first and second keyboard sections 112 114 can each be configured with an ergonomic shape, to facilitate convenient handheld operation.

In yet another related embodiment, as shown in FIG. 2, the first and second keyboard sections 112 114 can further comprise respectively first and second rear mounted keys 230 240, which are mounted on rear sides of respectively the first and second keyboard which can include respectively first upper and first lower rear mounted keys 236 238 and first upper and first lower rear mounted keys 246 248. The upper and lower keys can typically be configured for operation with respectively index and middle fingers of a user operating the keyboard section 112 114. The lower rear keys 238 248 can for example be assigned as the space key, and the upper rear keys 236 246 can for example be assigned as “Alt” and shift keys

In an embodiment, FIG. 2 shows a first keyboard section 112, which can also be referred to as a left keyboard section, that forms one half of a handheld split keyboard system 100. The keyboard section 112 includes a body section 202 that includes a plurality of physical keys 210. In the embodiment shown in FIG. 1, each key 210 can be pressed physically inward into the keyboard section 112 to trigger a switch (not shown) located underneath the key 210. The switching mechanism may be a dome-switch, as is well known in the prior art of keyboard construction. Other switch technologies could also be used, such as a membrane switch, a scissor-switch, a buckling-spring switch, a capacitive switch, or a hall-effect switch. It is also possible to implement the keys 210 with a touch-sensitive surface that does not require the physical translation of the key 210 to register the user's keystroke.

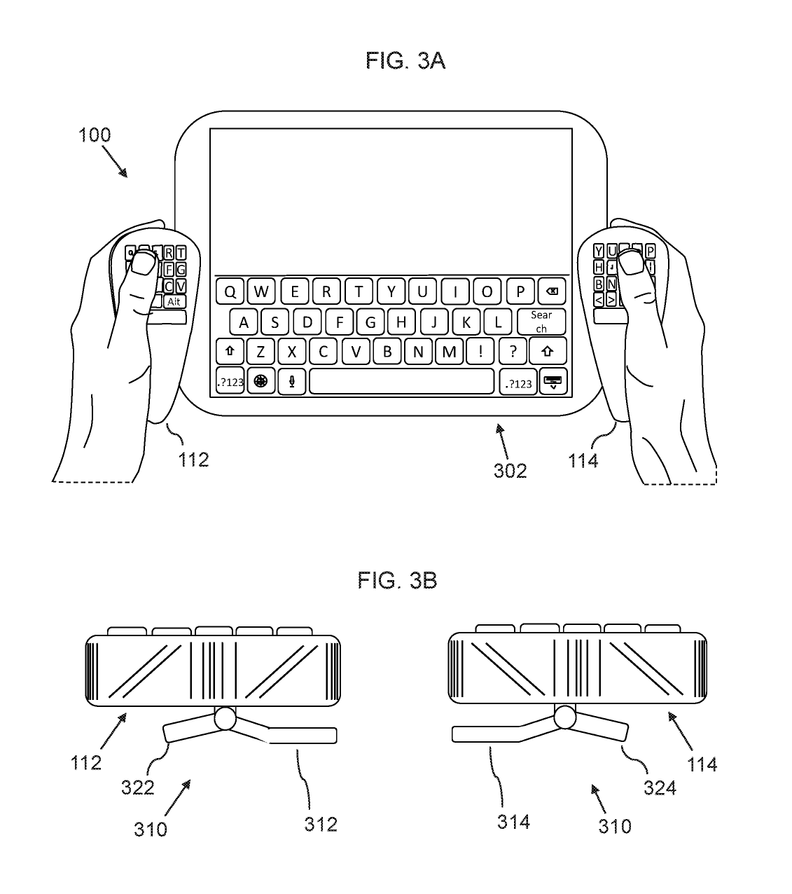

In a related embodiment, as shown in FIG. 3A, the right and left keyboard sections 112 114 can be configured to be attachable to a tablet computer 302 (or another computer device 302) via an attachment mechanism 310, which is connected to the body 102 104, which attachment mechanism 310 for example can be first and second clips 312 314 mounted on right and left rear sides of respectively the right and left keyboard sections 112 114, as shown in FIG. 3B, which shows a bottom view of the right and left keyboard sections 112 114. The clips can for example be configured to rotate to open when the user presses a clip lever 322 324 inward. In alternative further related embodiments, the attachment mechanism 310 can be a clip, a clamp, a hook and loop fastener, a suction cup, a pressure sensitive adhesive pad, an adhesive gel pad, and other conventional devices and methods for attaching a device to a tablet, laptop, screen, or other device.

In a further related embodiment, the attachment mechanism can be configured as a separable hinge, as described in U.S. Pat. No. 8,869,541, which is included herein by reference in its entirety. As disclosed in U.S. Pat. No. 8,869,541, the separable hinge can include a mechanism to attach the keyboard to the face of a tablet computer (such as a suction cup). By using a hinged attachment mechanism, the keyboard section 112 114 can be folded up away from the tablet computer 302 to temporarily allow a user to view beneath the keyboard section 112 114.

In a related embodiment, the keyboard section 112 can be designed to wirelessly communicate each stroke of its keys 210. Since the keyboard section 112 does not receive power through a wired connection to a power source, the keyboard section 112 will normally require battery power in order to operate. Like other battery-powered keyboards, the keyboard section 112 can save battery power by effectively turning off when no key 210 has been pressed for a period of time. The keyboard section can include a power light 230 to communicate to the user that the keyboard section 112 is currently powered on and has sufficient battery power to operate. In some embodiments, the power light 230 can be able to communicate when battery power is low, such as by blinking. In still other embodiments, the color of the power light 230 may indicate the connection status of the keyboard section 112 (whether the keyboard section 112 has established a data connection to another device).

In another related embodiment, FIG. 3A shows a second keyboard section 114 that forms the second half of a handheld split keyboard system 100. Like the first keyboard section 112, the second keyboard section 114 has a body 202 containing a plurality of keys 210 that are linked to a mechanism to receive keystrokes from a user. The second keyboard section 114 also can include an attachment mechanism to attach the second keyboard section 114 to a display face of a tablet computer or a screen, and a power indicator light 230 to disclose power and connection status to a user. The second keyboard section 114 can also move to a lower power mode during periods of non-use in order to save battery power, as described previously in connection with the first keyboard section 112.

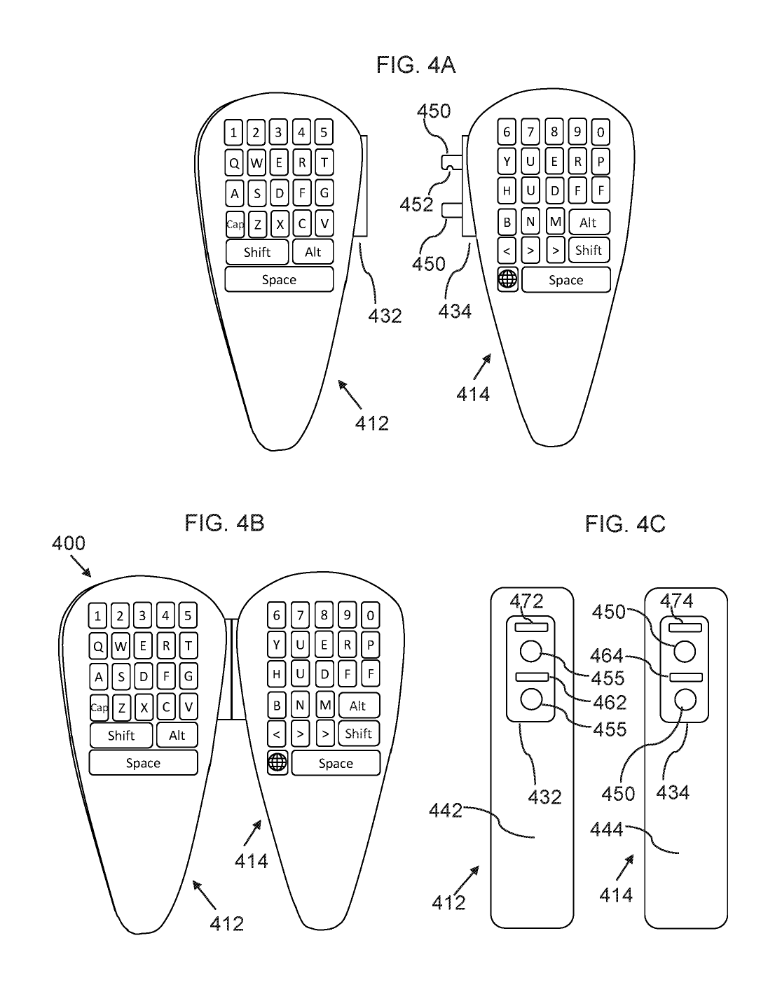

In a related embodiment, as shown in FIGS. 4A and 4B, the two keyboard sections 412 414 can optionally be joined together to form a single merged keyboard system 400, as shown in FIG. 4B, such that the first and second keyboard sections 412 414 are removably attachable. To facilitate the joining of the two keyboard sections 412 414 together, the keyboard sections can further include first and second joining sections 432 434, which are configured with matching receiving surfaces, such that the first and second joining sections 432 434 are attached to respectively right and left sides of the first and second bodies 102 104. To further facilitate the joining of the two keyboard sections 412 414 together, the second keyboard section 414 can utilize a pair of posts 450 found on the facing side 444 of the second keyboard section 414, which can be a facing side of the second joining section 434. The facing side 444 of keyboard section 414 is that side that faces the first keyboard section 112 when the two keyboard sections 412 114 are in use.

In one embodiment, the first keyboard section 412 and second keyboard section 414 combine to provide the letters of the alphabet in a “qwerty” keyboard configuration, with the first keyboard section 412 being positioned to the left of the second keyboard section 114 to create the qwerty configuration. In this position, the facing side 444 of the second keyboard section 414 will be positioned facing left toward the first keyboard section 412. Similarly, the facing side 442 of the first keyboard section 412 is that side of the first keyboard section 412 which faces the second keyboard section 414 during use (namely the right side in the examples shown in the Figures).

As shown in FIG. 4C, the posts 450 can mate with holes 455 found on the facing side 442 of the first keyboard section 412. In the preferred embodiment, each post 450 is constructed with an indentation 452 on a side portion of the post 450. A matching protrusion is located within each hole 455. By spring loading the protrusion, the distal end of the post 450 (that part of the post 450 most distal from the facing side 444 of the second keyboard section 414), may push aside the protrusion when the post 450 is inserted into the hole 455. By continuing to push the post 450 into the hole 455, the spring-biased protrusion will line up with the indentation 452 and hold the post 450 within the hole 455 by pushing into the indentation 452. The spring tension urges the protrusion against the indentation 452, which holds the two keyboard sections 412 414 together as a merged keyboard system 400. The user may later separate the merged keyboard system 400 by simply pulling the keyboard sections 412 414 apart.

In a related embodiment, only one of the two keyboard sections 112 114 directly interfaces with a tablet computer. This keyboard section is considered the master keyboard section, and it communicates with the tablet computer interface via a radio frequency signal, which can be a Bluetooth connection that complies with one of the standards of the Bluetooth Special Interest Group (such as the Bluetooth low energy, or “Bluetooth Smart,” standard for low power devices). The second keyboard section, known as the slave keyboard section, sends all of its keystrokes to the master keyboard. When the master keyboard receives keystrokes from the slave keyboard, it forwards those keystrokes on to the tablet computer over the Bluetooth interface. In the Figures, the first keyboard section 112 could be configured as the slave keyboard section and the second keyboard section 114 could be configured as the master keyboard section. The communication of keystrokes from the slave keyboard section 112 to the master keyboard section 114 can take place over a wired or wireless connection. In FIG. 4C, the first keyboard section 412 is shown with a male electrical connector 462 on its facing side 442 which interfaces with a matching female electrical connector 464 found on the facing side of the second keyboard section 412. When the two keyboard sections 412 414 are joined into the merged keyboard 400, keystrokes received on the first keyboard section 412 are communicated via the wired connection created by interfaces 462 464, and then sent via Bluetooth to the tablet computer 302.

In FIG. 3A, the two keyboard sections 112 114 are shown separated, located on the left and right side, respectively, of a tablet computer 302. As can be seen in this figure, the two keyboard sections 112 114 can be mounted directly on the sides of the tablet computer 302, such that they in some cases can partially overlap with a front of the tablet computer 302. The two keyboard sections 112 114 can be sized so that they can be reached by a user's thumbs while the user is holding the tablet computer 302. For instance, if tablet 302 has a longest dimension of between 9-10 inches, the keyboard section 112 can be sized such that the furthest reach from a left side of the tablet 302 to any key on the keyboard section 112 is less than 3 inches.

As is also the case in FIG. 4A, the facing side 442 of the first keyboard section 412 still faces the facing side 444 of the second keyboard section 414 in FIG. 3A, even though the two facing sides 442 444 are not in contact with one another. In the embodiment shown in FIG. 3A, the male and female connectors 462 464 cannot engage. In fact, FIG. 3A does not show the male connector 462 on the first keyboard section 112. In one embodiment, the male connector 462 can be a retractable connector that can be retracted into the facing side 442 of the first keyboard section 112 when it is not in use. In another embodiment, the male and female connectors 462 464 are simply excluded from the design and construction of the keyboard sections 112 114. In related embodiments, male and female connectors, can be reversed as male and female connectors, or they can be uniformly shaped connectors, such as flat magnet connectors.

In the embodiment shown in FIG. 4A, keystrokes received on the slave keyboard section 412 are sent wirelessly to the master keyboard section 414 before they are forwarded to the tablet computer 302 via a Bluetooth connection, or other type of wireless connection. In one embodiment, these keystrokes are transmitted from the slave keyboard section by an infrared transmitter 472. This transmitter 472 is located on the facing side 442 of the first keyboard section 412, and transmits an infrared signal to an infrared receiver 474 found on the facing side 444 of the second keyboard section 414. When a key 210 is pressed on the first keyboard section 412, it is translated into an infrared signal that is transmitted over the transmitter 472 to receiver 474. The second keyboard section 414 receives this signal, and translates it to a keystroke signal that is sent to the tablet computer 302.

In a different embodiment, the communication between the first and second keyboard sections 112 114 takes place over a radio frequency communication path as opposed to an infrared light communication path. This radio communication path between the first and second keyboard sections 112 114 can be formatted according to a Bluetooth protocol similar to the protocol used to communicate with the tablet computer 302. When using a Bluetooth protocol, it is advisable to configure the first keyboard section 112 to be generally non-discoverable except during the linkage between the first and second keyboard sections 112 114. This means that the tablet computer 302 will not detect the presence of the first (slave) keyboard section 112 even when the tablet 302 is attempting to link with an external keyboard. At the same time, the second keyboard section 114 will be discoverable. This means that the tablet computer 302 will sense only the Bluetooth connection of the second (master) keyboard section 114, and all communications between either keyboard section 112 114 will take place over the Bluetooth connection established between the second keyboard section 114 and the tablet computer 302.

As explained above, when the slave keyboard section 112 encounters a period of inactivity, it can turn off power to its internal components to save battery life until a user presses a key 210 on the keyboard section 112. The master keyboard section 114 may also power down, but it must power back up in response to a press of its own keys 210 or to a signal received from the slave keyboard section 112. If the master keyboard section 114 were to sleep in power off mode until a key 210 has been pressed, the master keyboard section 114 may not receive and properly handle a wireless signal from the slave keyboard section 112. To avoid this issue, the master keyboard section 114 can maintain power on its receiver components, such as the infrared receiver 474 or its Bluetooth receiver in order to be able to handle signals from the slave keyboard section 112. If the two keyboard sections 112 114 are connected via wire (such as through connectors 462 464), then the two keyboard sections 112 114 could wake simultaneously in response to the press of a key 210, on either keyboard section. In some embodiments, the master keyboard section 114 would operate identically to the slave keyboard section 112, and it would be necessary to press a key on the master keyboard section 114 to wake it before the master keyboard section 114 would transmit a signal received from the slave keyboard section 114. In these instances, a power button may be placed on the master keyboard section 114 that would wake it without transmitting a keystroke to the tablet computer 302.

In yet another embodiment, both keyboard sections 112 114 can establish separate and independent RF (e.g., Bluetooth) connections to the tablet computer 302. One advantage of this embodiment is that both keyboard sections 112 114 may sleep and avoid draining any power from their batteries until a key 210 is pressed by a user. A second advantage of this embodiment is that it is not necessary to establish a data communication path between the two keyboard sections 112 114, nor require two separate data pathways within the master keyboard section 114 for the transmission of keystrokes to the tablet computer 302. One disadvantage is that the operator of the tablet computer 302 must establish separate Bluetooth pairings with each keyboard sections 112 114, which may cause confusion for novice users.

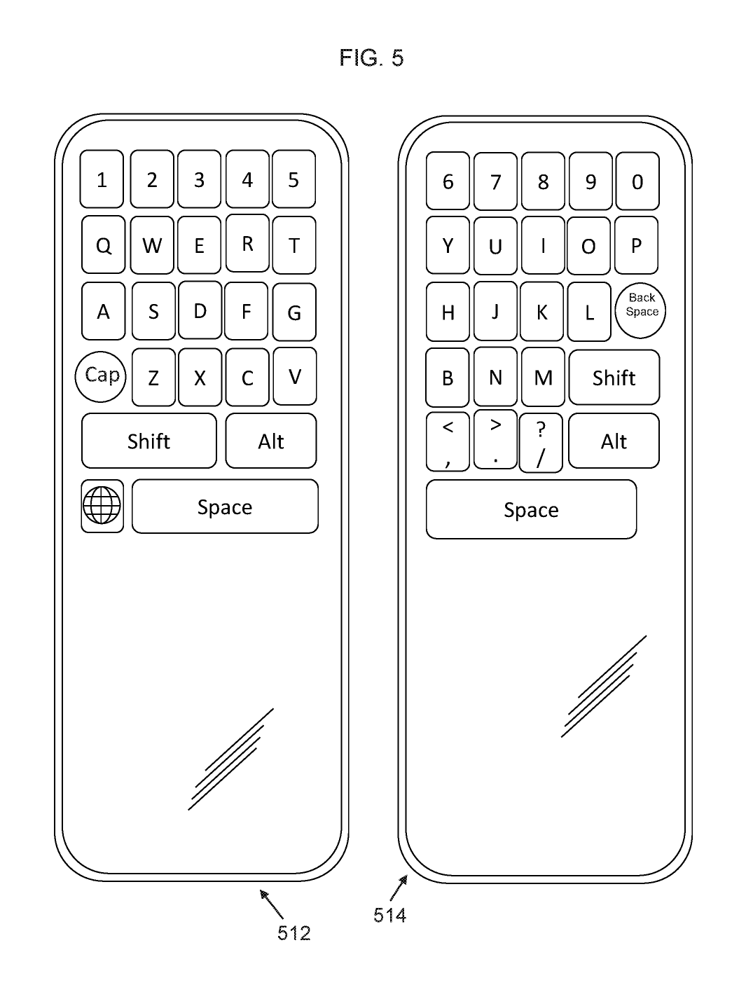

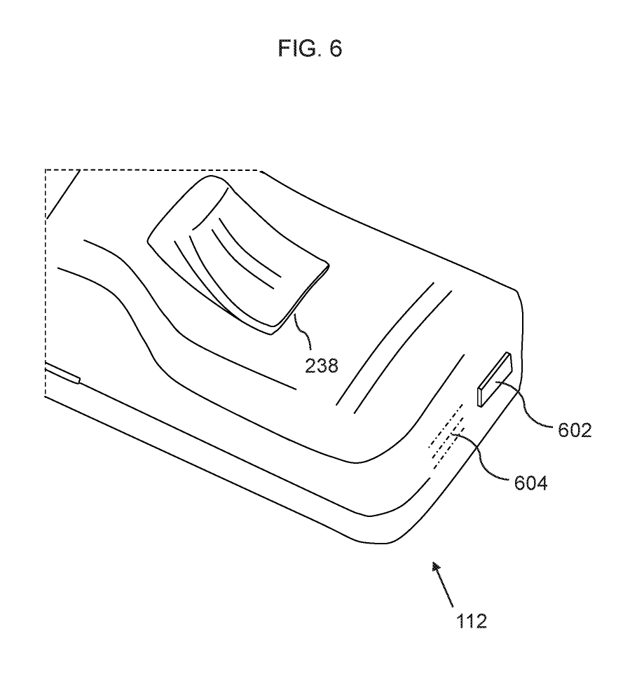

In another embodiment, FIG. 5 shows an alternative design of the first and second keyboard sections 512 514 with a substantially rectangular shape with rounded edges and corners.

In an embodiment, as shown in FIG. 6, one of the first and right keyboard sections 112 114, here shown as the first keyboard section 112, can further include a dictation recording function, such that the keyboard section further includes a stop/start recording button 602 and a speaker 604, which for example can both be positioned on a top side of the keyboard section 112, as shown. Other rear and front keys of the keyboard section 112 114 can be used to further control recording and playback.

FIG. 7A schematically shows an embodiment of a system 700A that uses a first (or slave) keyboard section 710 and a second (or master) keyboard section 720 to send keystroke signals to a computer device 730, which can be a tablet computer 302.

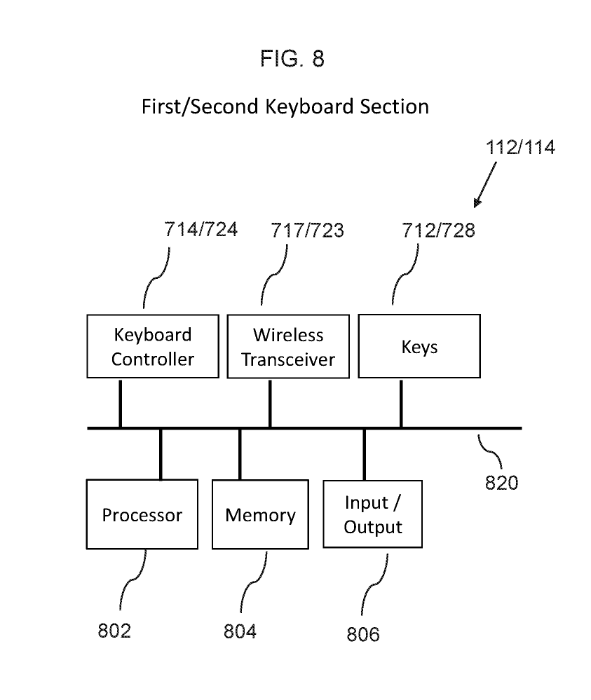

In a related embodiment, the first keyboard 710 receives a keystroke from one of the keys 712 found on the keyboard 710. A keyboard controller 714 receives this keystroke from the source key 712 and then creates an appropriate keyboard keystroke signal 750 for that key 712. The keyboard processor 802, as shown in FIG. 8, can be a programmed, general-purpose microcontroller such as those made available through Intel Corporation (Santa Clara, Calif.), or can be an application-specific integrated circuit (or “ASIC”) or a field programmable device (such as an FPGA) specifically designed to handle the processing requirements of the keyboards 710, 720. While it is preferred that the keyboard processor 714 be formed as a single silicon chip or electronic element, it is possible to implement the different functions of the keyboard processor 714 in physically separate electronic devices. A wireless transmitter 716 then sends the keyboard keystroke signal 750 to the second keyboard section 720. In one embodiment, the wireless transmitter 716 transmits infrared light signals or radio frequency signals from the first keyboard section 710 to the second keyboard section 720.

The second keyboard section 720 has a wireless receiver 722 that receives the keyboard keystroke signal 750 from the first keyboard section 710. The second keyboard section 720 also contains a keyboard processor 724 that converts the keyboard keystroke signal 750 into a signal that would be understood by the tablet computer 302. A wireless transmitter 726 built into the second keyboard section 720 then transmits this tablet keystroke signal 760.

The tablet computer 302 receives the tablet keystroke signal 760 via its wireless receiver 732. A processor 734 receives the tablet keystroke signal 760 and implements the keystroke. The processor 734 will implement the keystroke according to its operating system 740 and the applications and related data 742 that are currently operating on the processor 734. The tablet computer 302 stores the operating system 740 and the applications and related data 742 in its memory 738. The results of the processing are then displayed on the display/touch input device 736 of the tablet 302.

The second keyboard section 720 also has a plurality of keys 728 that receive input from a user of the system 700A. When these keys 728 register a keystroke, a keystroke signal is sent from the keys 728 to the keyboard processor 724 on the keyboard section 720. The keyboard processor 724 processes this signal, and converts the signal into a tablet keystroke signal that could be sent by the wireless transmitter 726 to the tablet computer 302.

Keyboard section 720 can be designed to transmit keystroke signals 760 to the tablet computer 302 whether the keystroke originated with a pressed key 712 on the first keyboard section 710, or a pressed key 728 on the second keyboard section 720. In use, the system 700A will be receiving keystrokes on both keyboards 710, 720, with a user using both of their hands to press keys 712, 728 on either keyboard section 710 720. Because it is important for the signals 760 for each keystroke to be sent to the tablet computer 302 in the same order that the related keys 712, 728 were pressed by the user, it is sometimes necessary to delay the keystroke signals 760 that originate on the second keyboard section 720. This is because the processing required before the transmission of a signal based on pressing keys 712 can take a fraction of a second longer to implement than processing required before the transmission of a signal based on pressing keys 728. In these circumstances, a delay can be implemented before transmitting keystrokes received on keys 728. After this delay, these keystroke signals 760 are transmitted by the wireless transmitter 726, and are implemented by the tablet computer 302.

FIG. 7B schematically shows an alternative embodiment of a system 700B that includes first and second keyboard sections 710 720, each including wireless transceivers 717 723, such that the first and second keyboard sections 710 720 both are configured to send keystroke signals directly to a computer device 730.

In a related embodiment, as shown in FIG. 8, a first or second keyboard section 112 114 can include:
a) A processor 802;
b) A non-transitory memory 804;
c) An input/output 806; A plurality of keys 712 728;
d) A keyboard controller 714 724;
e) A wireless transceiver 717 723, which can alternatively be a wireless transmitter 717 723; all connected via
f) A data bus 820.

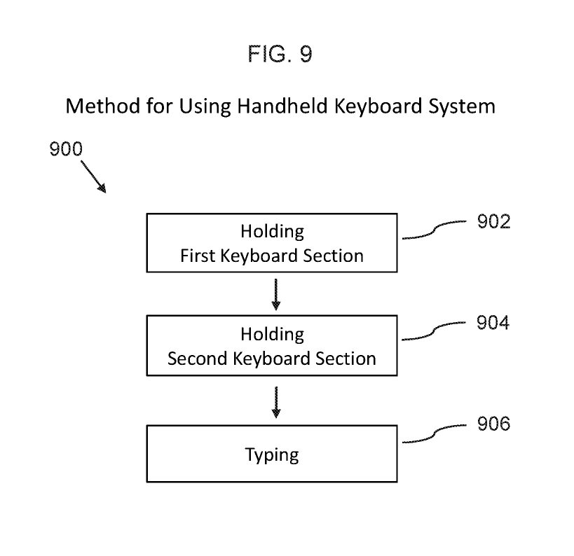

In an embodiment, as illustrated in FIG. 9, a method for using a handheld keyboard system 900, can include:
a) Holding first keyboard section 902, wherein a user holds the first keyboard section 112 using a first hand 182;
b) Holding second keyboard section 904, wherein a user holds the second keyboard section 114 using a second hand 184;
c) Typing 906, wherein the user types on a computer device 730 by concurrently:
   i. Depressing keys on the first keyboard section 112, such that first keystroke information is transmitted from the first keyboard section 112 to the computer device 730;
   ii. Depressing keys on the second keyboard section 114, such that second keystroke information is transmitted from the second keyboard section 114 to the computer device 730.

FIGS. 7A, 7B, 8 and 9 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 7A, 7B, and 8 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the keyboard section 112 are to be interpreted in the most general manner.

For example, the processors 802 can include a single physical microprocessor or microcontroller, a cluster of processors, a datacenter or a cluster of datacenters, a computing cloud service, and the like.

In a further example, the non-transitory memory 804 can include various forms of non-transitory storage media, including random access memory and other forms of dynamic storage, and hard disks, hard disk clusters, cloud storage services, and other forms of long-term storage. Similarly, the input/output 806 can each respectively include input/output devices, such as screens, keyboards, pointing devices, motion trackers, communication ports, and so forth.

Furthermore, it shall be understood that the first and second keyboard sections 112 114 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the first and second keyboard sections 112 114 communicates with the computer device 730 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the . . . device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A handheld split keyboard system, comprising:
a) a first keyboard section, comprising:
a first body; and
a first plurality of front keys, which are mounted on a front side of the first body; and
b) a second keyboard section, comprising:
a second body; and
a second plurality of front keys, which are mounted on a front side of the second body;
wherein the first and second keyboard sections are configured for handheld use, such that the first and second keyboard sections are configured to be held by respectively a first hand and a second hand of a user;
wherein the first and second keyboard sections are configured to communicate keystroke information to a computer device via a wireless connection.

2. The handheld split keyboard system of claim 1, wherein the first and second keyboard sections are configured for typing with respectively a first thumb and a second thumb of the user, such that the first and the second thumb depress keys of respectively the first and second plurality of keys.

3. The handheld split keyboard system of claim 1, further comprising:
a) at least one first rear key, which is mounted on a rear side of the first body; and
b) at least one second rear key, which is mounted on a rear side of the second body.

4. The handheld split keyboard system of claim 3, wherein:
a) the at least one first rear key, comprises:
a first upper rear key; and
a first lower rear key;
wherein the first upper rear key and the first lower rear key are positioned for use with respectively index and middle fingers of the first hand of the user; and
b) the at least one second rear key, comprises:
a second upper rear key; and
a second lower rear key;
wherein the second upper rear key and the second lower rear key are positioned for use with respectively index and middle fingers of the second hand of the user.

5. The handheld split keyboard system of claim 1, wherein the right and left keyboard sections are configured to be removably attachable to left and right sides of a tablet computer with respectively a first and second attachment mechanism, which is connected to respectively the first body and the second body, wherein the first and second keyboard sections are configured to communicate the keystroke information to the tablet computer via the wireless connection.

6. The handheld split keyboard system of claim 5, wherein the first and second attachment mechanisms are respectively first and second clips, which are mounted on respectively right and left rear sides of respectively the first and second keyboard sections.

7. The handheld split keyboard system of claim 1, wherein the first and second keyboard sections are configured to be removably attachable.

8. The handheld split keyboard system of claim 7, wherein:
a) the first keyboard section further comprises
a first joining section, further comprising at least two holes; and
b) the second keyboard section further comprises
a second joining section, further comprising at least two post, which are configured to be insertable into the at least two holes;
such that facing sides of the first and second joining sections are configured to be securely connectable, such that the at least two posts are inserted into the at least two holes, when the first and second joining sections are connected.

9. The handheld split keyboard system of claim 1, wherein:
a) the first keyboard section further comprises:
a first processor;
a first non-transitory memory;
a first input/output;
the first plurality of keys;
a first keyboard controller, which receives first keystroke information from the first plurality of keys; and
a first wireless transceiver, which is configured to transmit the first keystroke information to the computer device; all connected via
a first data bus; and
b) the second keyboard section further comprises:
a second processor;
a second non-transitory memory;
a second input/output;
the second plurality of keys;
a second keyboard controller, which receives second keystroke information from the second plurality of keys; and
a second wireless transceiver, which is configured to transmit the second keystroke information to the computer device; all connected via
a second data bus.

10. A handheld split keyboard system, comprising:
a) a first keyboard section, comprising:
a first body; and
a first plurality of front keys, which are mounted on a front side of the first body; and
b) a second keyboard section, comprising:
a second body; and
a second plurality of front keys, which are mounted on a front side of the second body;
c) a computer device;
wherein the first and second keyboard sections are configured for handheld use, such that the first and second keyboard sections are configured to be held by respectively a first hand and a second hand of a user;
wherein the first and second keyboard sections are wirelessly connected to the computer device, such that the first and second keyboard sections communicate keystroke information from the first and second plurality of front keys to the computer device.

11. The handheld split keyboard system of claim 10, further comprising:
a) at least one first rear key, which is mounted on a rear side of the first body; and
b) at least one second rear key, which is mounted on a rear side of the second body.

12. The handheld split keyboard system of claim 11, wherein:
a) the at least one first rear key, comprises:
a first upper rear key; and
a first lower rear key;
wherein the first upper rear key and the first lower rear key are positioned for use with respectively index and middle fingers of the first hand of the user; and
b) the at least one second rear key, comprises:
a second upper rear key; and
a second lower rear key;
wherein the second upper rear key and the second lower rear key are positioned for use with respectively index and middle fingers of the second hand of the user.

13. The handheld split keyboard system of claim 11, wherein the right and left keyboard sections are configured to be removably attachable to left and right sides of a tablet computer with respectively a first and second attachment mechanism, which is connected to respectively the first body and the second body, wherein the first and second keyboard sections are configured to communicate the keystroke information to the tablet computer via the wireless connection.

14. The handheld split keyboard system of claim 5, wherein the first and second keyboard sections are configured to be removably attachable.

15. A method for using a handheld keyboard system, comprising:
a) holding a first keyboard section, wherein a user holds the first keyboard section using a first hand of the user;
b) holding a second keyboard section, wherein a user holds the second keyboard section using a second hand of the user; and
c) typing, wherein the user types on a computer device by concurrently:
depressing first front keys on the first keyboard section, such that first keystroke information is transmitted from the first keyboard section to the computer device; and
depressing second front keys on the second keyboard section, such that second keystroke information is transmitted from the second keyboard section to the computer device.

16. The method for using a handheld keyboard system of claim 15, wherein the user types on the first and second keyboard sections with respectively a first thumb and a second thumb of respectively the first and second hands.

17. The method for using a handheld keyboard system of claim 15, wherein the user types on at least one first rear key and at least one second rear key of respectively the first and second keyboard sections.

18. The method for using a handheld keyboard system of claim 17, wherein
a) the at least one first rear key, comprises:
a first upper rear key; and
a first lower rear key; and
b) the at least one second rear key, comprises:
a second upper rear key; and
a second lower rear key;
wherein the user types on the first upper rear key and the first lower rear key with respectively index and middle fingers of the first hand;
wherein the user types on the second upper rear key and the second lower rear key with respectively index and middle fingers of the second hand.

19. The method for using a handheld keyboard system of claim 15, wherein the right and left keyboard sections are configured to be removably attachable to left and right sides of a tablet computer with respectively a first and second attachment mechanism, which is connected to respectively the first body and the second body, wherein the first and second keyboard sections are configured to communicate the keystroke information to the tablet computer via the wireless connection.

20. The method for using a handheld keyboard system of claim 15, wherein the first and second keyboard sections are configured to be removably attachable.
